(19) United States
(12) Patent Application Publication
(10) Pub. No.: US 2010/0064161 A1
(43) Pub. Date: Mar. 11, 2010

(54) Data Reserving Method for a Redundant Array of Independent Disks and Related Data Reserving Device and System

(76) Inventor: Chih-Hung Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/369,752

(22) Filed: Feb. 12, 2009

(30) Foreign Application Priority Data
Sep. 11, 2008 (TW) 097134827

(51) Int. Cl. G06F 1/32; G06F 12/16

(52) U.S. Cl. 713/324; 711/114; 711/E12.103

(57) ABSTRACT

A data reserving method for a redundant array of independent disks (RAID) includes detecting an alternating-current (AC) power inputted to a power supply device used to transform the AC power into a direct-current (DC) power for the RAID, and storing data of a memory module of the RAID into a non-volatile storage device when the AC power is not inputted to the power supply device.

### BACKGROUND OF THE INVENTION

1. Field of the Invention

The present invention relates to a data reserving method for a redundant array of independent disks (RAID) and related data reserving device and system, and more particularly, to a data reserving method for a redundant array of independent disks and related data reserving device and system capable of reducing an area and cost, and ensuring normal operation.

2. Description of the Prior Art

A redundant array of independent disks (RAID) system is a storage technique combining a plurality of disks, and has a performance reaching or exceeding an expensive and high-capacity disk. Since RAID has a higher data integration, fault tolerance and storage capacity than a single disk, RAID is always utilized in servers, and composed of same disks.

Technically, RAID integrates a plurality of disks to a single logical sector, so an operating system regards the disks as a single disk. In this situation, when the system is turned off or powered off, RAID needs to store configuration information or temporary data (namely unfinished written in) to a memory module, to ensure a normal operation when turned on the system. In order to increase operation speed, the memory module is usually a volatile memory, such as a random access memory. Since data stored in the volatile memory will be deleted due to power off, when the system stops providing power because of turning off, or other reasons (such as power failure), RAID provides power to the memory module through an extra power storage device, such as a battery backup unit, to make the memory module to continuously reserve data.

Please refer to FIG. 1, which is a schematic diagram of a RAID system 10 according to the prior art. The RAID system 10 includes disks HD_0˜HD_n, a memory module 100, a power supply device 102, a disk control unit 104, and a battery backup unit 106. The power supply device 102 is utilized for transforming an alternating-current (AC) power PWR_AC into a direct-current (DC) power PWR_DC, to provide power to the disk control unit 104. The disk control unit 104 is utilized for driving the disks HD_0˜HD_n, and may include a north bridge chip, a serial advanced technology attachment (SATA) control chip, etc. In addition, the disk control unit 104 stores configuration information and temporary data of the disks HD_0˜HD_n into the memory module 100. The memory module 100 is a volatile memory. The battery backup unit 106 provides power to the memory module 100 when the power supply device 102 stops providing power, to make the memory module 100 to continuously reserve data.

In other words, when the system stops providing power, the battery backup unit 106 is utilized for ensuring that data stored in the memory module 100 will not be deleted. Therefore, when the system is restarted, the operating system can correctly exam a related configuration of the RAID system 10, and then write unfinished data into the disks, to make the RAID system 10 to function normally. However, the additional battery backup unit 106 will increase production cost and occupy more area, and notice that, power stored in the battery backup unit 106 is related to time of being not providing power. In other words, if power stored in the battery backup unit 106 is lower, time of continuously providing power to the memory module 100 is decreased. On the contrary, if power stored in the battery backup unit 106 is higher, time of continuous providing power to the memory module 100 is increased. In other words, time of system being not providing power is longer. Certainly, though capacity of the battery backup unit 106 for storing power is as higher as better, an area occupied by the battery backup unit 106 and manufacture cost are increased correspondingly. In addition, though disregarding an area, manufacture cost, etc., and increasing power storage capacity of the battery backup unit 106 as possible, power provided by the battery backup unit 106 will be consumed completely if time of the system being turned off is long enough. Meanwhile, the battery backup unit 106 may not provide power to the memory module 100 because of damage or breakdown, and then the operating system cannot process the successive operations correctly when the system is restarted, so as to affect utilization convenience.

In a word, the method of providing power to the memory module through the battery backup unit increases area and cost, but still cannot ensure the RAID system to function normally. Therefore, an improvement for the prior art is necessary.

### SUMMARY OF THE INVENTION

It is therefore a primary objective of the claimed invention to provide a data reserving method for a redundant array of independent disks and related data reserving device and system.

The present invention discloses a data reserving method for a redundant array of independent disks (RAID), which includes detecting an alternating-current (AC) power inputted to a power supply device used for transforming the AC power into an direct-current (DC) power for the RAID, and storing data of a memory module of the RAID into a non-volatile storage device when the AC power is not inputted to the power supply device.

The present invention further discloses a data reserving device for a redundant array of independent disks (RAID), which includes a non-volatile storage device, a detection unit utilized for detecting an alternating-current (AC) power inputted to a power supply device used for transforming the AC power into an direct-current (DC) power for the RAID, and a control unit utilized for storing data of a memory module of the RAID into a non-volatile storage device when the AC power is not inputted to the power supply device.

The present invention further discloses a redundant array of independent disks (RAID) which includes a plurality of disks, a memory module, a power supply device coupled to an alternating-current (AC) power, and used for transforming the AC power into an direct-current (DC) power, a disk control unit coupled to the plurality of disks, the memory module and the power supply device, and used for receiving the DC power to drive the plurality of disks and storing configuration information and temporary data of the plurality of disks into the memory module, and a data reserving device. The data reserving device includes a non-volatile storage device, a detection unit used for detecting the AC power, and a control unit used for storing data of the memory module into the non-volatile storage device when the AC power is not inputted to the power supply device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a redundant array of independent disks according to the prior art.

FIG. 2 is a schematic diagram of a redundant array of independent disks according to an embodiment of the present invention.

FIG. 3 is a schematic diagram of a data reserving process according to an embodiment of the present invention.

FIG. 4 is a schematic diagram of a power transformation of a power supply device shown in FIG. 2.

FIG. 5 is a schematic diagram of a data reserving process according to an embodiment of the present invention.

### DETAILED DESCRIPTION

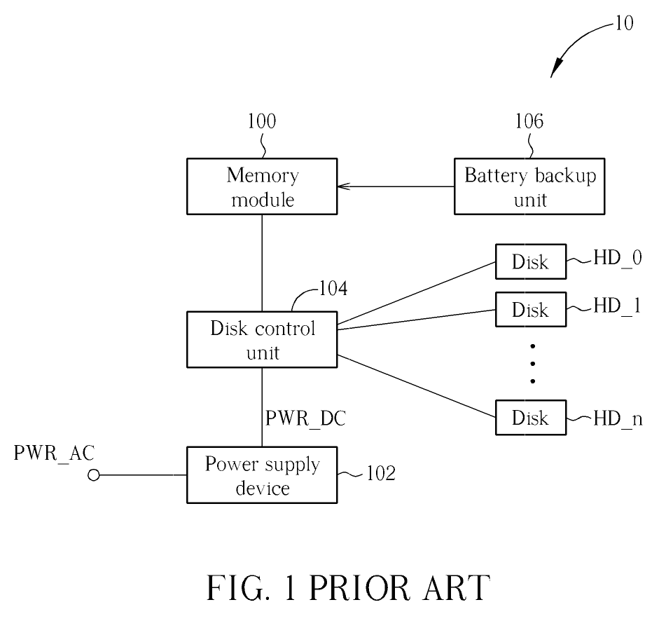

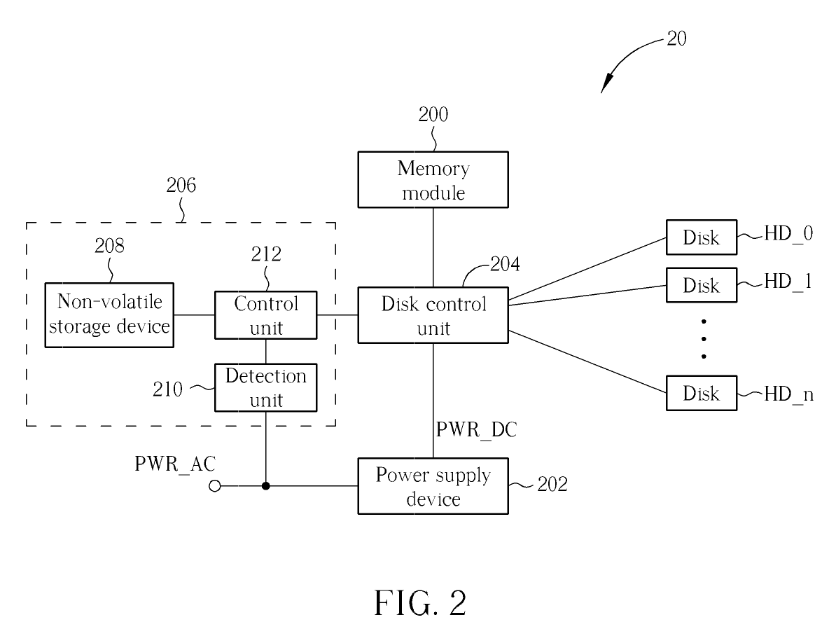

Please refer to FIG. 2, which is a schematic diagram of a redundant array of independent disks (RAID) system 20 according to an embodiment of the present invention. The RAID system 20 includes disks HD_0˜HD_n, a memory module 200, a power supply device 202, a disk control unit 204, and a data reserving device 206. In FIG. 2, operations of the disks HD_0˜HD_n, the memory module 200, the power supply device 202, and the disk control unit 204 are similar to the disks HD_0˜HD_n, the memory module 100, the power supply device 102, and the disk control unit 104 shown in FIG. 1. That is, the power supply device 202 is used for transforming an alternating-current (AC) power PWR_AC into a direct-current (DC) power PWR_DC, to provide power to the disk control unit 204. The disk control unit 204 is used for driving the disks HD_0˜HD_n, and may include a north bridge chip, a serial advanced technology attachment (SATA) control chip, etc. Meanwhile, the disk control unit 204 stores configuration information and temporary data of the disks HD_0˜HD_n into the memory module 200. The memory module 200 is a volatile memory. In other words, data stored in the memory module 200 will be deleted because of power off. In order to avoid that the data stored in the memory module 200 is deleted due to power off, the RAID system 20 stores the data of the memory module 200 through the data reserving device 206, to aid the successive operations.

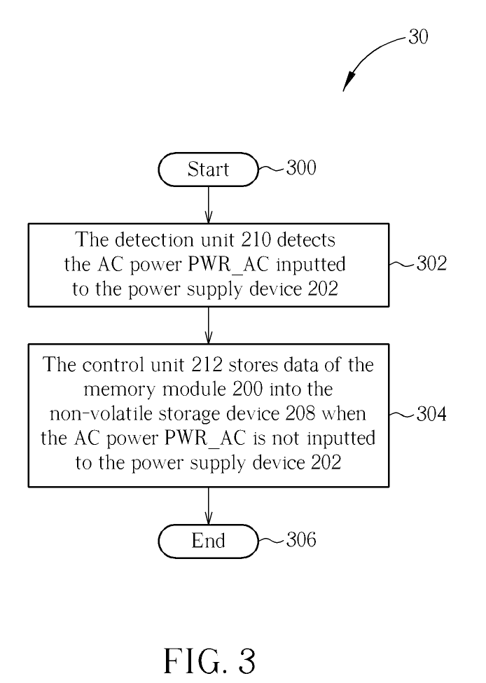

In FIG. 2, the data reserving device 206 includes a non-volatile storage device 208, a detection unit 210 and a control unit 212. Data stored in the non-volatile storage device 208 will not be deleted because of power off. The non-volatile storage device 208 is preferably a flash memory of a non-volatile memory, etc. The detection unit 210 is coupled to the AC power PWR_AC, and is used for detecting a power on or power off state of the AC power PWR_AC. The control unit 212 can be integrated in the disk control unit 204, and is used for storing data of the memory module 200 into the non-volatile storage device 208 according to a detection result from the detection unit 210 when the AC power PWR_AC is not inputted to the power supply device 202. Please refer to FIG. 3 for an operation of the data reserving device 206.

Please refer to FIG. 3, which is a schematic diagram of a data reserving process 30 according to an embodiment of the present invention. The data reserving process 30 is an operation process of the data reserving device 206, and is used for storing data of the memory module 200 in the RAID system 20. The data reserving process 30 includes the following steps.

Step 300: Start.

Step 302: The detection unit 210 detects the AC power PWR_AC inputted to the power supply device 202.

Step 304: The control unit 212 stores data of the memory module 200 into the non-volatile storage device 208 when the AC power PWR_AC is not inputted to the power supply device 202.

Step 306: End.

According to the data reserving process 30, the control unit 212 stores data of the memory module 200 into the non-volatile storage device 208 when the detection unit 210 detects that the AC power PWR_AC is not inputted to the power supply device 202. Since data stored in the non-volatile storage device 208 will not be deleted because of power off, when the power supply device 202 stops providing power, the RAID system 20 can utilize the non-volatile storage device 208 to reserve data of the memory module 200 without using an extra power storage device, such as the battery backup unit 106 shown in FIG. 1. In this situation, when the system is restarted, the operating system can correctly exam a related configuration of the RAID system 20, and write unfinished data into the disks, to make the RAID system 20 to function normally.

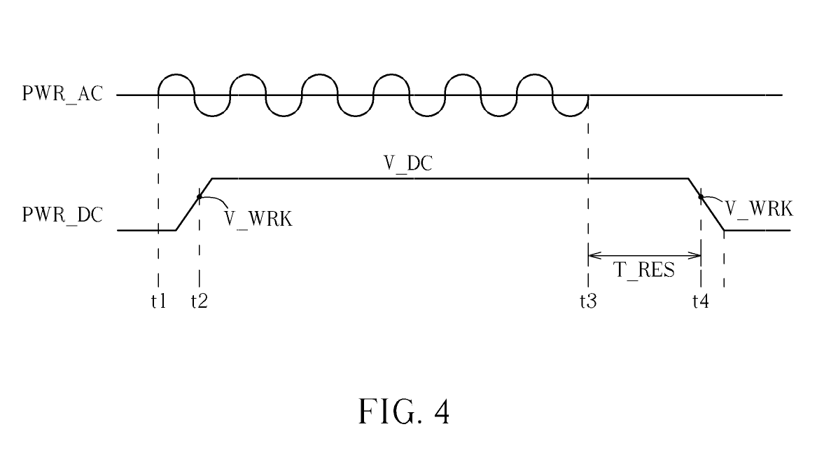

In a word, in the RAID system 20, when the power supply device 202 stops providing power, the control unit 212 stores data of the memory module 200 into the non-volatile storage device 208, so the RAID system 20 does not need to provide an extra power to the memory module 200. Power for the control unit 212 operating is provided by a residual power of the power supply device 202. Please refer to FIG. 4, which is a schematic diagram of power transformation of the power supply device 202. In FIG. 4, from top to bottom are respectively corresponded to the AC power PWR_AC and the DC power PWR_DC. In addition, V_DC indicates a stable voltage of the DC power PWR_DC, and V_WRK indicates a lowest voltage for the RAID system 20 to function normally, which is usually 90% of the V_DC. The AC power PWR_AC is provided at a time point t1, and meanwhile the power supply device 202 starts transforming the AC PWR_AC into the DC power PWR_DC through an effect of an internal capacitor storing charges, to gradually increase a voltage of the DC power PWR_DC. When the AC power is continuously provided until a time point t2, the voltage of the DC power PWR_DC climbs to the V_WRK, which indicates that the RAID system 20 starts operating. The AC power PWR_AC is not provided if the system is turned off or powered off at a time point t3, and then the power supply device 202 starts releasing the residual power of the internal capacitor due to a capacitor discharge effect, so as to gradually decrease the voltage of the DC power PWR_DC from V_DC to V_WRK at a time point t4. In other words, from the time point t3 to t4, namely T_RES, the residual power of the power supply device 202 can drive the RAID system 20. Therefore, the data reserving device 206 stores data of the memory module 200 into the non-volatile storage device 208 by utilizing the duration T_RES.

Briefly speaking, the power supply device 202 keeps releasing power for driving the RAID system 20 (namely a voltage of the residual power is larger than V_WRK) after the AC power is not provided. Therefore, when the detection unit 210 detects that the AC power PWR_AC is not provided to the power supply device 202 at the time point t3, the control unit 212 stores data of the memory module 200 into the non-volatile storage device 208 by utilizing the duration T_RES, to reserve data of the memory module 200 by utilizing the feature of the non-volatile storage device 208. Moreover, in order to make the control unit 212 to store data of the memory module 200 into the non-volatile storage device 20 more effectively, the disk control unit 204 can reduce an amount of data stored in the memory module 200. In addition, in order to extend the duration T_RES, besides increasing the internal capacitor of the power supply device 202, the control unit 212 can turn power of the disks HD_0˜HD_n off when the AC power PWR_AC is not provided, to make the disks HD_0˜HD_n to stop consuming the residual power of the power supply device 202, so as to extend the duration T_RES.

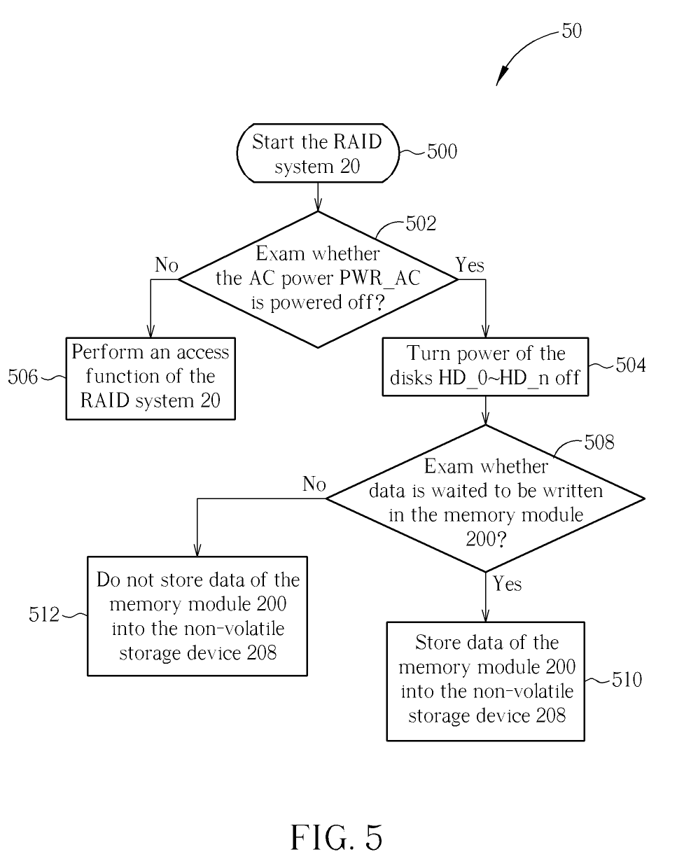

The above operation method can be concluded into FIG. 5, which is a schematic diagram of a data reserving process 50 according to an embodiment of the present invention. The data reserving process 50 is an operation process of the data reserving device 206, and is used for reserving data of the memory module 200 in the RAID system 20. The data reserving process 50 includes the following steps.

Step 500: Start the RAID system 20.

Step 502: Exam whether the AC power PWR_AC is powered off. Perform Step 504 if the AC power PWR_AC is powered off. Otherwise, perform Step 506.

Step 504: Turn power of the disks HD_0˜HD_n off, and perform Step 508.

Step 506: Perform an access function of the RAID system 20.

Step 508: Exam whether data is waited to be written in the memory module 200. Perform Step 510 if there is data waited to be written. Otherwise, perform Step 512.

Step 510: Store data of the memory module 200 into the non-volatile storage device 208.

Step 512: Do not store data of the memory module 200 into the non-volatile storage device 208.

The data reserving process 50 is a conclusion of the previous description, so the detailed description is omitted herein.

In the prior art, the RAID system needs to install the battery backup unit to provide power to the memory module when the system is powered off. This kind of method not only wastes area and increases cost, but also cannot ensure the RAID system to function normally. In comparison, the control unit 212 stores data of the memory module 200 into the non-volatile storage device 208 by using the residual power of the power supply device 202 when the system is powered off. Therefore, the RAID system 20 can reduce an area and cost for the battery backup unit, and more important, ensure that the configuration information or temporary data will not be deleted because of power off, so as to maintain the successive operation.

In conclusion, when the system is powered off, the RAID system of the present invention stores data of the memory module into the non-volatile storage device, so the operating system can correctly exam the related configuration of the RAID system, and write unfinished data in the disks when restarting the system, to ensure a normal operation. Therefore, the present invention can reduce an area and cost of the battery backup unit, and more important, ensure that the configuration information or temporary data will not be deleted because of power off, so as to make the RAID system to function normally.

Those skilled in the art will readily observe that numerous modifications and alterations of the device and method may be made while retaining the teachings of the invention.

What is claimed is:

1. A data reserving method for a redundant array of independent disks (RAID) comprising:
detecting an alternating-current (AC) power inputted to a power supply device used for transforming the AC power into an direct-current (DC) power for the RAID; and
storing data of a memory module of the RAID into a non-volatile storage device when the AC power is not inputted to the power supply device.

2. The method of claim 1, wherein the memory module stores configuration information and temporary data of the RAID.

3. The method of claim 2 further comprising reducing an amount of data stored in the memory module by reducing an amount of configuration information and temporary data of the RAID.

4. The method of claim 1, wherein storing data of the memory module of the RAID into the non-volatile storage device when the AC power is not inputted to the power supply device is storing data of the memory module into the non-volatile storage device with a residual DC power of the power supply device when the AC power is not inputted to the power supply device.

5. The method of claim 4 further comprising storing electricity of the residual DC power of the power supply device.

6. The method of claim 1 further comprising turning off a plurality of disks of the RAID when the AC power is not inputted to the power supply device.

7. A data reserving device for a redundant array of independent disks (RAID) comprising:
a non-volatile storage device;
a detection unit, for detecting an alternating-current (AC) power inputted to a power supply device used for transforming the AC power into an direct-current (DC) power for the RAID; and
a control unit, for storing data of a memory module of the RAID into a non-volatile storage device when the AC power is not inputted to the power supply device.

8. The data reserving device of claim 7, wherein the memory module stores configuration information and temporary data of the RAID.

9. The data reserving device of claim 7, wherein the control unit is utilized for storing data of the memory module of the RAID into the non-volatile storage device with a residual DC power of the power supply device when the AC power is not inputted to the power supply device.

10. The data reserving device of claim 7, wherein the control unit is further utilized for turning off a plurality of disks of the RAID when the AC power is not inputted to the power supply device.

11. A redundant array of independent disks (RAID) comprising:
a plurality of disks;
a memory module;
a power supply device, coupled to an alternating-current (AC) power, for transforming the AC power into an direct-current (DC) power;
a disk control unit, coupled to the plurality of disks, the memory module and the power supply device, for receiving the DC power to drive the plurality of disks, and storing configuration information and temporary data of the plurality of disks into the memory module; and
a data reserving device comprising:
a non-volatile storage device;
a detection unit, for detecting the AC power; and
a control unit, for storing data of the memory module into the non-volatile storage device when the AC power is not inputted to the power supply device.

12. The RAID of claim 11, wherein the disk control unit is further utilized for reducing an amount of data stored in the memory module by reducing an amount of configuration information and temporary data of the RAID.

13. The RAID of claim 11, wherein the control unit is utilized for storing data of the memory module into the non-volatile storage device with a residual DC power of the power supply device when the AC power is not inputted to the power supply device.

14. The RAID of claim 13, wherein the power supply device comprises a capacitor utilized for storing electricity of the residual DC power of the power supply device.

15. The RAID of claim 11, wherein the control unit is further utilized for turning off the plurality of disks when the AC power is not inputted to the power supply device.

16. The RAID of claim 11, wherein the control unit is integrated with the disk control unit.
